(19) United States
(12) Patent Application Publication
(10) Pub. No.: US 2004/0168078 A1
(43) Pub. Date: Aug. 26, 2004

(54) Apparatus, system and method for protecting function return address

(76) Inventors: Carla E. Brodley, West Lafayette, IN (US); Terani N. Vijaykumar, West Lafayetta, IN (US); Hilmi Ozdoganoglu, West Lafayette, IN (US); Benjamin A. Kuperman, West Lafayette, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/726,229

(22) Filed: Dec. 2, 2003

Related U.S. Application Data
(60) Provisional application No. 60/430,848, filed on Dec. 4, 2002.

(51) Int. Cl. G06F 11/30

(52) U.S. Cl. 713/200

(57) ABSTRACT

An apparatus, system, and method for protecting a computing device from attacks while the computing device is in operation is provided. In one embodiment, the apparatus includes an input/output unit, a control unit, an execute unit, and first and second memory areas. The first memory area is accessible by a user of the computing device. The second memory area is not accessible by any users. The second memory area is configured to store return addresses and stack pointers.

### RELATED APPLICATIONS

This application claims the benefit of U.S. Provisional Patent Application Serial No. 60/430,848, filed Dec. 4, 2002, incorporated herein by reference.

### BACKGROUND AND SUMMARY OF THE INVENTION

The present invention relates to the protection of computing devices and computer systems from security attacks involving malicious code or data. Computing devices and computer systems, especially those connected to networks such as the Internet, are increasingly vulnerable to such attacks. Statistics indicate that the number of attack incidents rose from a total of 21,756 in the year 2000 to 73,359 during the first three quarters of 2002. Attacks are increasingly automated, sophisticated, and focused on network infrastructure. The term “computing device” is used herein to refer generally to computers, computer systems (including systems of networked computers), servers, workstations, multi-user machines, and other general- or special-purpose computing devices now known or developed in the future (including, but not limited to, handheld, laptop or portable devices).

Computer programs often contain procedure calls or function calls. Procedure or function calls affect the flow of execution of the calling program because they initiate the execution of other computer programs or programming instructions from within the calling program. A procedure call or function call causes computer program instructions of the called procedure or function to be executed. After a called procedure or function has executed, control is returned to the calling program. Functions or procedures can be nested; that is, a called function or procedure can itself call other functions or procedures, or itself (i.e., recursive functions).

A data structure known as a “stack” is commonly used to implement procedure or function calls. A stack is a section of memory used to store data relating to a called function or procedure in a “last in, first out” manner. Data in a stack are removed from the stack in the reverse order from which they are added, so that the most recently added item is removed first. During execution of a computer program process, data are frequently added or “pushed” onto a stack and removed or “popped” off the stack in accordance with programming instructions.

In the implementation of function or procedure calls, data are pushed onto a stack when a function or procedure is called and popped when the function or procedure returns control to the calling program. The data include information relating to the called function or procedure, such as variables, pointers, saved values, and the return address of the calling program. In general, the return address is the address of the instruction in the calling program that immediately follows the function or procedure call. In other words, the return address points to the next instruction to execute after the current function or procedure finishes executing or exits (or “returns”).

An attacker can cause a program to execute arbitrary code by modifying or altering return addresses. When a function is called, an attacker injects malicious program code somewhere in the computer memory and modifies the return address to point to the start of the malicious code. When the called function returns or exits, the program execution will continue from the location pointed to by the modified return address. With successful modification of the return address, the attacker can execute commands with the same level of privilege as that of the attacked program. For example, the attacker may be able to use the injected code to spawn new processes and take control of the computing device.

There are several known methods for overwriting the function return address and redirecting execution of a computer program. Such methods include buffer overflow attacks and format string attacks. Buffer overflow attacks are often the undesirable side effect of unbounded string copy functions. The most common example from the “C” programming language involves the “strcpy( )” function, which copies each character from a source buffer to a destination buffer until a “null” character is reached. As implemented in many versions of C, the strcpy ( ) function does not check whether the destination buffer is large enough to accommodate the source buffer's contents. For many computer architectures (e.g., x86, SPARC, MIPS) the stack grows down from high to low memory addresses, whereas a string copy on the stack moves up from low to high addresses. In this situation, it is trivial to overflow a buffer to overwrite the return address, which is higher in the stack than the function's local variables. However, it is still possible to overflow the buffer even if the stack grows in the same direction as the string copy. An attacker can exploit this vulnerability to overflow the buffer and overwrite the return address.

There are various types of buffer overflow attacks known in the art, including attacks that directly overwrite the return address on the stack; those that overwrite a pointer variable adjacent to the overflowed buffer to make it point to the return address and then overwrite the return address by an assignment to the pointer; and those that overwrite a function pointer adjacent to the overflowed buffer, so that when the function is called, control transfers to the location pointed to by the overwritten function pointer. See, for example, Aleph One, “Smashing the stack for fun and profit,” published in Phrack vol. 7 issue 49 (November 1996) (accessed at http://secinf.net/auditing/Smashing The Stack For Fun And Profit.html, Apr. 7, 2003).

Similar to buffer overflow attacks, format string attacks modify the return address in order to redirect the flow of control to execute the attacker's code. In general, format strings allow a programmer to format inputs and outputs to a program using conversion specifications.

For example, in C, the “printf” function can be used to output a character string. In the statement printf(“% s is % d years old.”, name, age), the string in quotes is the format string, % s and % d are conversion specifications, and name and age are the specification arguments. When the printf( ) function is called, the specification arguments are pushed onto a stack along with a pointer to the format string. When the function executes, the conversion specifiers are replaced by the arguments on the stack. A vulnerability arises when programmers write statements like “printf(string)” instead of using the proper syntax: “printf(“% s”, string)”. The output from the two printf statements will appear identical unless “string” contains conversion specifiers. For each conversion specifier, printf( ) will pop an argument from the stack. An attacker can take advantage of this vulnerability to overwrite the return address and redirect program execution. See, for example, James Bowman, “Format string attacks: 101” (Oct. 17, 2000) (published at http://www.sans.org/rr/malicious/format string.php) (accessed Apr. 7, 2003).

Many tools and methods have been devised to stop these attacks with varying levels of security and performance overhead. In general, these existing tools and methods can be organized into two groups: those that modify the compiler and therefore require that the source code be recompiled, and those that require a modification to the system software. See, for example, Sections 3.1 and 3.2 of Ozdoganoglu et al., “SmashGuard: A Hardware Solution to Prevent Attacks on the Function Return Address”, Purdue Technical Report, # TRE ECE 02-08 (December 2002), incorporated herein by this reference.

In general, known solutions either provide a high level of security or a high level of system performance. Solutions that trade off a high level of security for better performance are eventually bypassed by the attackers and prove incomplete. On the other hand, high security solutions seriously degrade system performance due to the high frequency of integrity checks and high cost of software-based memory protection. Another issue that diminishes the feasibility of these tools and methods is their lack of transparency to the user or to the operating system.

In contrast, the present invention provides high security with little performance degradation. Another advantage of the present invention is that no recompilation of source code is necessary. Further, the present invention does not require modification of the architecture instruction set and therefore can be quickly incorporated into today's microprocessors.

In accordance with the present invention, a hardware-based solution to protecting the stack of return addresses is provided, which achieves both security and performance superiority. The present invention also provides solutions for “special” circumstances such as process context switches, “setjmp” and “longjmp” function calls, and deeply nested function calls.

The present invention provides an apparatus for protecting a computing device from attacks during operation. The apparatus comprises an input/output unit, a control unit coupled to the input/output unit, an execute unit coupled to the control unit, a first memory area including memory that is accessible by a user of the computing device, and a second memory area including memory that is not accessible by the user. The second memory area is configured to store a plurality of return addresses and stack pointers.

In one embodiment, the execute unit is operable to execute a plurality of operations, including a first operation which stores a first return address in the first memory area and second memory area, a second operation which compares the first return address with a second return address retrieved from the first memory area and a third operation which generates an exception if the comparison indicates a mismatch between the first return address and second return address.

The present invention further provides a computing device comprising means for receiving data and programming instructions, processing the data according to the instructions, storing return addresses generated by the means for processing in a first memory area and in a second memory area that is not accessible by computer users, and evaluating a return address from the first memory area and a return address from the second memory area to determine whether an attack on a return address has occurred.

Still further, the present invention provides a computer-readable medium that includes instructions that operate to prevent attacks on return addresses during execution of a computer program. The instructions are executable to store a first return address in a first memory area and in a second memory area that is not accessible by computer users, retrieve a second return address from the first memory area, compare the first return address and the second return address, and generate an exception if the first return address is different from the second return address.

Yet further, the present invention provides a computer-readable medium for use in connection with a computing device. The computer-readable medium includes a plurality of instructions that, when executed, protect the computing device from attacks on return addresses. The computer-readable medium further comprises a first memory which is configured to store a plurality of return addresses during execution of a computer program, protected from access by users of the computing device during execution of the computer program, and accessed by instructions that compare the plurality of return addresses with return addresses stored in a second memory in the computing device.

Still further, the present invention provides a method of preventing attacks on return addresses during execution of a computer program on a computing device. The method comprises the steps of storing a first return address in a first memory that is accessible to computer users and in a second memory that is not accessible to computer users, retrieving a second return address from the first memory, comparing the first return address and the second return address, and generating an exception if the results of the comparing step indicate that an attack has been attempted.

### BRIEF DESCRIPTION OF THE DRAWINGS

FIG. 1 shows a schematic diagram of an exemplary computing device.

FIG. 2 shows a logical representation of an exemplary organization of a portion of the memory shown in FIG. 1.

FIG. 3 shows a schematic diagram of an embodiment of a processor in accordance with the present invention.

FIG. 4 shows a flow diagram of a method in accordance with the present invention.

FIG. 5 shows an example of a computer program including function and procedure calls.

FIGS. 6A-6H show logical representations of portions of memory structures when setjmp and longjmp function calls are encountered, in accordance with the present invention.

### DETAILED DESCRIPTION OF THE DRAWINGS

The present invention provides an apparatus, system and method for protecting against attacks on return addresses. The present solution provides both high security and high performance without requiring any source code to be recompiled and without any modifications to the architecture instruction set.

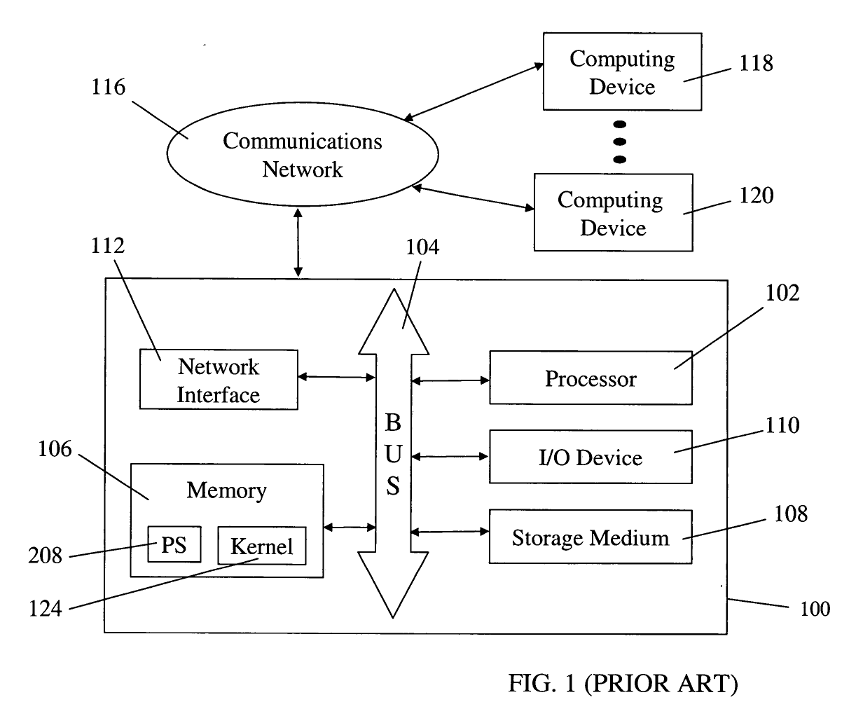

The present invention is adaptable for use in connection with virtually any computing system or computing device. FIG. 1 shows a schematic diagram of an exemplary computing device or computer system (referred to generally hereinafter as a “computing device”) 100. In FIG. 1, computing device 100 is coupled to a communications network 116. A plurality of other computing devices or computer systems 118, 120 are also coupled to communications network 116 in the embodiment of FIG. 1.

In general, the computing devices 100, 118, 120 are personal computer systems, desktop computer systems, computing workstations, servers, multiuser machines, handheld computing devices (such as cellular phones with computing capabilities, personal digital assistants, and other similar devices), other special purpose computing devices, and/or any other suitable computing device or system. In the exemplary embodiment, at least computing device 100 includes a processor 102, a system bus 104, a memory 106 (such as RAM, ROM, etc.) and a storage medium 108, as is well-known in the art. Optionally, computing device 100 also includes one or more user I/O devices 110 (such as visual display devices, mouse, keyboards, keypads, touch pads, etc.), and/or a network interface 112 as will be readily appreciated by one of ordinary skill in the art.

It is noted that the computing devices and components described above are merely exemplary, and in other embodiments those skilled in the art may elect to replace all or portions of these components with suitable alternatives without undue experimentation.

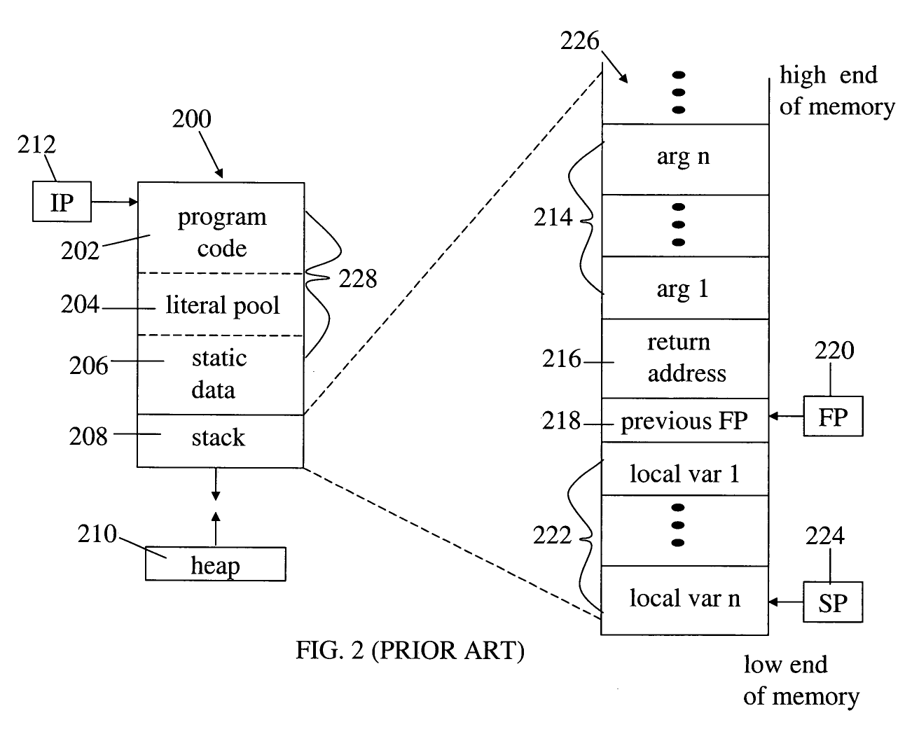

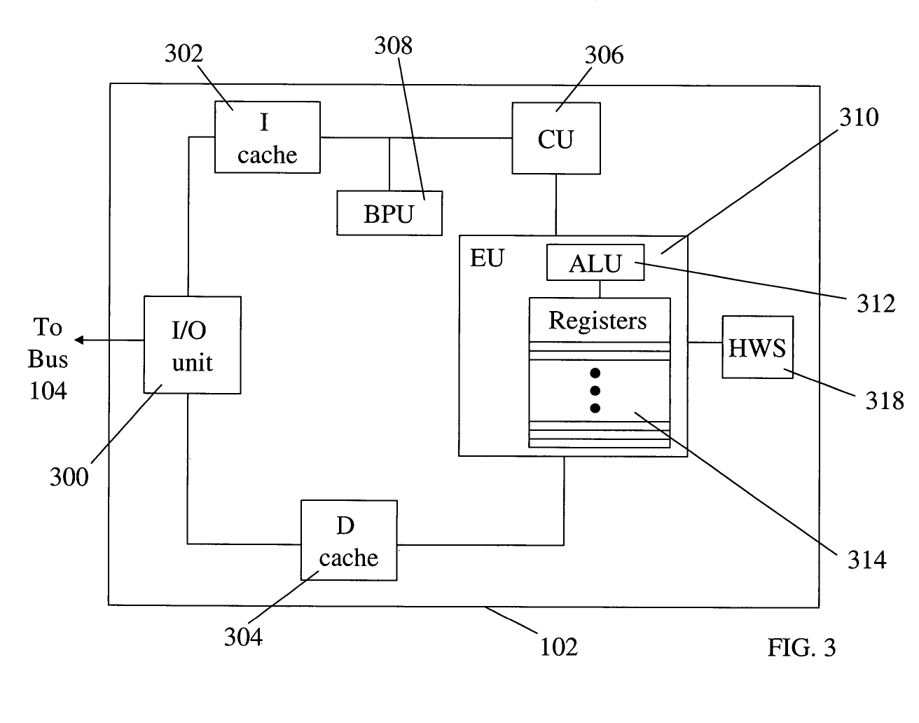

FIG. 2 shows an example of the organization of a portion 200 of memory 106 that is used by processor 102 during execution of a process initiated by computer programming instructions. Processor 102 is shown in FIG. 3, which is discussed below. Memory portion 200 includes three logical areas of memory used by a process. A text-only portion 228 contains program code or instructions 202, a literal pool 204 and static data 206. A stack 208 is used to implement functions and procedures that are included in computer programming instructions processed by processor 102. A heap 210 is used for memory that is dynamically allocated by the process during run time. An instruction pointer 212 indicates the memory location of the programming instruction being executed. It will be readily understood by those skilled in the art that the present invention is adaptable to operate with the Intel x86, SPARC, MIPS, or other architectures with slight variations in the details.

Stack 208 is of primary interest for purposes of this disclosure, because a return address 216 is stored on stack 208 when a function or procedure is called, and is popped off of stack 208 when the function returns or exits. Stack 208 is generally referred to in the art as the “process memory”, “process stack”, “software stack”, “run time stack”, or “program stack”. For ease of discussion, stack 208 (generally, including the embodiment of FIG. 2 as well as alternative embodiments implemented using other computer architectures) may be referred to herein as the “process stack”.

When programming instructions include a call to a function or procedure, during a portion of the process known as the function prologue, function or procedure arguments 214 are pushed onto stack 208 and then return address 216 is pushed onto stack 208. The function prologue finishes by pushing a previous frame pointer 218 onto stack 208, followed by local variables 222 of the called function or procedure. Because functions and procedures can be nested, the previous frame pointer 218 provides a handy mechanism for quickly deallocating space on the stack when a called function exits.

A view of a portion of stack 208 known as a stack frame 226 (discussed below) is shown on the right side of FIG. 2. Arguments 214, return address 216, previous frame pointer 218, and local variables 222 comprise stack frame 226. When a function or procedure includes nested functions or procedures, stack 208 includes multiple stack frames 226 that are pushed onto stack 208 in reverse order as each nested function or procedure is called.

During a portion of the process known as the function epilogue, return address 216 is read off of stack 208 and stack frame 226 is deallocated dynamically by moving the stack pointer 224 to the top of the previous stack frame.

As mentioned above, the return address 216 in the stack frame 226 at the top of stack 208 points to the next instruction to execute after the current function or procedure returns (or finishes, or exits). When the called function or procedure exits, the program execution will continue from the location pointed to by return address 216.

However, as discussed above, at least portions of the process stack 208 including return address 216 are accessible by computer users. As a result, attacks on return address 216 are possible. In order to prevent such attacks, in one embodiment, the present invention includes a modification of computing device 100.

As shown in the embodiment of FIG. 3, in accordance with the present invention, a small portion of memory, referred to herein as a “hardware stack” 318, is provided, which is suitable for storing return address stack pointers, but is not accessible to computer users. The hardware stack may also be referred to herein as the “secure storage or “secure memory area”. It will be appreciated by those of skill in the art that the hardware stack 318 may be located within the processor or outside the processor 102, as may be necessary or desirable in a given configuration.

FIG. 3 shows a simplified schematic view of an embodiment of processor 102, as modified in accordance with the present invention. Processor 102 generally includes an I/O unit 300, an instruction (“I”) cache 302, a data (“D”) cache 304, a control unit (“CU”) 306, a branch processing unit (“BPU”) 308, an execute unit (“EU”) 310, an arithmetic logic unit (“ALU”) 312, and a plurality of registers 314. It is understood that the embodiment of processor 102 shown in FIG. 3 is intended to be functionally representative of the many types of available processors, and that the specific components, names of components, and other specific structural details will vary depending upon the type or brand of processor actually used.

I/O unit 300, also known as a bus interface, operably couples processor 102 to system bus 104 so that it can interact with memory 106 and the rest of computing device 100. Instruction cache 302 and data cache 304 are used to temporarily store computer programming instructions and data, respectively, received via I/O unit 300, which are to be processed by processor 102. Control unit 306 controls the flow of data and instructions to execute unit 310. Branch processing unit 308 detects computer programming instructions that include a branch instruction, which is an instruction that alters or redirects the flow of program execution. In the illustrated embodiment, BPU 308 executes an algorithm to predict the flow of program execution based on the branch instruction and forwards that information to control unit 306. Control unit 306 then orders the instructions according to the flow predicted by BPU 308, decodes the instructions, and sends the decoded instructions to execute unit 310.

Execute unit 310 executes the instructions using the appropriate data, as indicated by the instructions, and sends the results to memory 106 via I/O unit 300. Execute unit 310 includes ALU 312 and a plurality of registers 314. ALU 312 performs arithmetic and logical operations as specified in the program instructions. Registers 314 store data used by the instructions being executed and/or interim or temporary data used or created during execution of the instructions.

In the embodiment of FIG. 3, hardware stack 318 is provided within processor 102. A modification to the hardware of processor 102 is made to provide this secure memory area. Hardware stack 318 is provided in addition to process stack 208, described above. Process stack 208 is stored in memory 106 during execution of a computer program.

In the illustrated embodiment, hardware stack 318 is preferably a 1 Kb private register array, which holds 256 function return addresses (for 32-bit address architectures such as Intel x86) and 128 return addresses (for 64-bit address architectures such as Alpha). However, it is understood that other suitable implementations would work equally as well. For example, a portion of kernel memory 124 could be used for hardware stack 318.

In the illustrated embodiment, hardware stack 318 has a limit on its size because it is located inside processor 102, where there is no dynamic memory allocation. If the size of the private register array is not sufficient to hold all of the return addresses (i.e., where there are more than 256 or 128 levels, respectively, of function nesting), a portion of hardware stack 318 is paged or copied to kernel memory 124 of main memory 106. When this occurs, the portion of kernel memory 124 that stores the copied portion of the hardware stack 318 is considered to be an extension of hardware stack 318, and is therefore part of the “secure memory area”. In order to reduce the frequency of transfers from hardware stack 318 to kernel memory 124, a group of return addresses (e.g., 50 at a time) may be copied to kernel memory 124 each time the private register array is filled up.

Hardware stack 318 is secure because no read or write instructions are permitted to or from the private register array. Therefore, the return addresses stored in hardware stack 318 are not accessible by any computer users. Kernel memory 124 is also protected from access by computer users because, like all other operating system kernel operations, the operating system protects it from access by other processes.

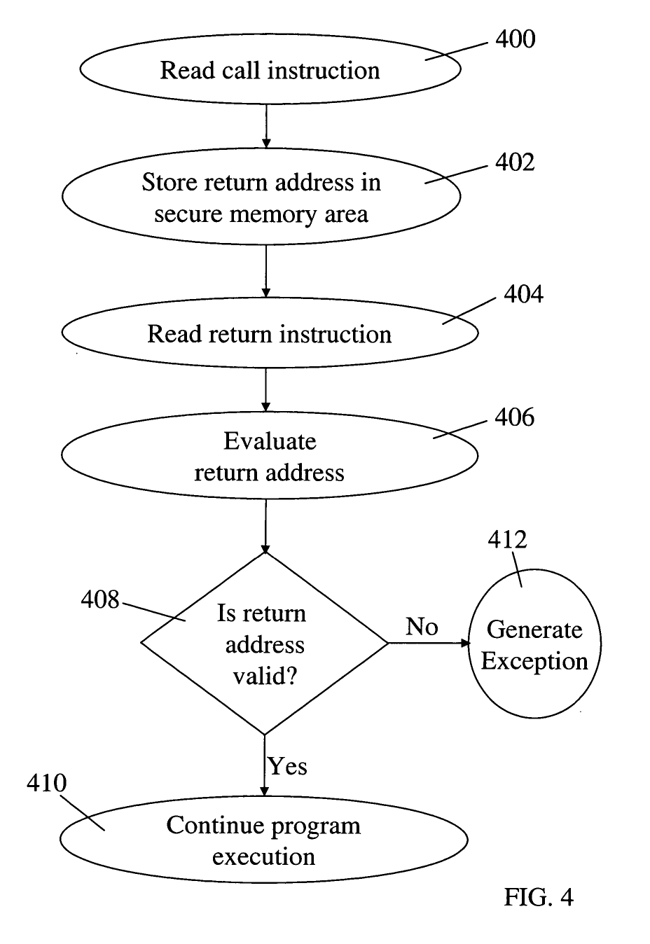

FIG. 4 shows a flow diagram for a method of protecting return addresses in accordance with the present invention. In the illustrated embodiment, the Alpha CPU architecture is used to explain the method of the present invention because it has a RISC instruction set which is simple to explain and simulate. However, those skilled in the art will appreciate that any suitable computer architecture (such as Alpha, Intel, SPARC, or MIPS) may be used without significant variations in the details of the present invention.

As is known, during execution of computer program instructions, a function or procedure call instruction may be encountered. Referring to FIG. 4, a call instruction is encountered and read at step 400. In the Alpha architecture, one of registers 314, known as a “general purpose register 26” (not shown), is used implicitly for storing the return address 216 of the current function. This register is one of a plurality (e.g., 32) of general-purpose integer registers provided in the Alpha architecture.

At step 400, using the Alpha architecture, when a function is called, a Jump-to-Subroutine (“jsr”) or Branch-to-Subroutine (“bsr”) instruction normally writes the address of the next instruction after the function call to the general purpose register 26 and the program execution continues from the address of the called function. When a nested function is called, the contents of the general purpose register 26 is copied to process stack 208 (in software via code generated by the compiler) and general purpose register 26 is loaded with the return address of the newly called function.

At step 402, computer program instructions are executed (either in software or hardware) to copy return address 216 to the secure memory area, e.g. hardware stack 318 and/or kernel memory 124. Using the Alpha architecture, the jsr and bsr instructions are modified to copy the contents of the general purpose register 26 to the top of hardware stack 318. The called function or procedure is then executed.

When the called function finishes executing or exits, a return instruction occurs. At step 404, a return instruction is encountered and read. In the Alpha architecture, the return (“ret”) instruction copies the contents of register 26 to instruction pointer 212. In accordance with the present invention, the return instruction is modified to retrieve the last return address on the top of hardware stack 318. Thus, a return instruction pops the most recent return address from the top of hardware stack 318.

The current return address 216 is evaluated at step 406. At step 406, the most recent return address popped from hardware stack 318 is compared to the current return address 216 stored on process stack 208. In the Alpha architecture, the return address popped from hardware stack 318 is compared with the current value of the general purpose register 26.

In the illustrated embodiment, step 408 determines whether there is a mismatch between the two return addresses. Alternatively, only the address on the hardware stack 318 is evaluated. If there is a mismatch (or, alternatively, if the address on the hardware stack 318 is invalid), then a hardware exception is raised at step 412. At step 412, the exception handler may handle the exception in a variety of ways known in the art. For example, the process may be interrupted or terminated, and or a message or report may be generated and communicated to a system operator and/or log file. If there is no mismatch, then the program continues executing at step 410.

### Timing of the Return Address Comparison

Certain complexities of modern processors require special handling. For example, many modern processors execute program instructions out of program order and/or speculatively under branch prediction. Accordingly, return instructions may be executed under misspeculation and/or out of program order. Consequently, comparing the return address 216 of the return instruction with the return address on top of the hardware stack at the time of execution may not be reliable. Thus, according to one aspect of the present invention, the comparison performed at step 406 is performed at the time the return instruction commits, which occurs in program order and after all outstanding speculations are confirmed.

Below is a description of one embodiment of the return address comparison aspect of the present invention, as implemented using the Alpha architecture. Description of alternative embodiments is provided in the attached Appendix, which is incorporated in its entirety herein by this reference.

In the Alpha architecture, the return instruction does not carry the general purpose register 26 value with it at commit because the register 26 value is written to a register file (not shown) at execution, which occurs well before commit. Thus, to obtain the general purpose register 26 value at commit, the register file is read using a register read port (not shown).

In the Alpha architecture, a register file has sufficient data read and write ports to enable it to handle the maximum possible number of references by all instructions issued simultaneously. The maximum number of ports used by a single instruction is two (e.g., reading two source operands). Therefore, the maximum number of read ports implemented is twice the issue width of processor 102. The issue width of processor 102 is the number of instructions that can be issued simultaneously subject to the number of functional units of register 26 available to make the comparison with the return address on process stack 208.

For example, if processor 102 has an issue width of “k”, k instructions are issued simultaneously, and all k instructions need to read two source operands, then processor 102 encounters a stall. In a pipelined architecture such as Alpha, while an instruction is issuing (reading source operands, getting ready to execute), another instruction can be at the commit stage, e.g., trying to complete a return instruction. If all data ports are already being used, then the return instruction cannot read the register 26 value.

Therefore, in accordance with another aspect of the present invention, the issuing of instructions is stalled to allow a port to be used for the return instruction. In an alternative embodiment, an extra read port is added to the register file to ensure that the register 26 value can be read. It is an engineering decision whether to add an extra read port to eliminate the stalls or just to stall one of the issuing instructions. It is preferred to simply stall the issuing instructions if the stalls occur infrequently.

To handle situations involving context switching or deeply nested function calls, portions of hardware stack 318 are “mapped” to kernel memory 124 as discussed below.

### Handling Context Switching

A context switch function operates to switch a currently running process with another process that is ready to execute. Context switching is used, for example, to implement a concurrent multi-process operating system. The context switch function is called by an exception handler (which is raised by a timer interrupt) either when the allowed time quota for execution of the running process expires, or when the running process is blocked (e.g., for I/O). The context switch function checks to see whether there is a higher priority process ready to execute. If not, the interrupted process continues to execute until the next call to the context switch function. When the context switch executes, the current process and processor state information is saved in a structure in kernel memory 124 called the Process Control Block (“PCB”). Thus, to handle process context switches, in accordance with another aspect of the present invention, the contents of the hardware stack 318 for the running process is paged out either to the PCB or to a memory location pointed to by a special pointer in the PCB, and the contents of the hardware stack 318 for the scheduled process is paged in.

Thus, when a context switch is encountered, the previous process's stack contents are saved and the new process's stack contents are restored. These activities are performed without adding any special instructions to the instruction set. In accordance with the present invention, memory mapping similar to memory-mapped I/O (known in the art) is used. Using the memory mapping procedure of the present invention, the normal processor load or store instructions are used to read and write the contents of hardware stack 318. Part of the address space is mapped to hardware stack 318 in a similar manner to which other parts of the address space are memory-mapped to I/O devices. A regular load or store access to this part of the address space thus translates to a read or write access to hardware stack 318, much like memory-mapped I/O devices are read and written. I/O devices are protected from direct access by user-level code via virtual memory protection. Similarly, direct access to hardware stack 318 is forbidden by virtual memory protection of the part of the address space mapped to hardware stack 318. Thus, only the operating system can read or write the memory-mapped stack.

Swapping the contents of hardware stack 318 at every context switch function call is not expected to cause a substantial overhead for two reasons. First, context switches happen infrequently (tens of milliseconds). Second, the overhead incurred by copying two 1 Kb arrays (one for the process being swapped out and the other for the process being swapped in) is negligible with respect to the overhead of the rest of the context switch function. The storage and retrieval of the contents of hardware stack 318 to/from kernel memory 124 is as safe as all other kernel operations because the operating system protects the kernel's memory space from other processes.

### Handling Deeply Nested Function Calls

As discussed above, hardware stack 318 has a hard limit on its size because it is inside processor 102. This means that hardware stack 318 may fill up for programs that have deeply nested function calls. In the illustrated embodiment, hardware stack 318 is a 1 Kb stack of registers, which holds 256 32-bit addresses (e.g., x86) or 128 64-bit addresses (e.g., Alpha). To handle function calls that are nested deeper than 128 (or 256) times, in accordance with another aspect of the present invention, a hardware stack overflow exception is raised, which will copy the contents of hardware stack 318 to a location in kernel memory 124. In the illustrated embodiment, this location in kernel memory 124 is a stack of stacks and every time a stack is full, it is appended to the previous full stack. Another exception, a hardware stack underflow, is raised when hardware stack 318 is empty, to page in the last saved full stack from kernel memory 124. Just as with context switches, saving and retrieving hardware stack 318 from kernel memory 124 is handled by the kernel so it is not accessible by computer users.

### Handling Setjmp and Longjmp Functions

One of the more complicated aspects of protecting return addresses involves handling “setjmp” and “longjmp” functions. In general, a setjmp function in C (or analogous function in an alternative programming language) stores context information for the current stack frame and execution point into a buffer, and a longjmp function (or analogous function) causes that stack frame and execution point to be restored. This allows a program to quickly return to a previous location, effectively short-circuiting any intervening return instructions. For example, in a complex search algorithm, the setjmp function may be used to mark where in the program to return to (the “entry point”) once a searched-for item is found. Then, various search algorithms are called and executed. When a searched-for item is found, the program calls the longjmp function to return back to the entry point. However, since this process avoids using the function call and return instructions, hardware stack 318 becomes inconsistent with process stack 208. More particularly, the longjmp function moves the stack pointer 224 back to the previous location, so the inconsistency is with the location that is pointed to as top-of-stack.

To protect return addresses when setjmp and longjmp functions are encountered, both the return address and stack pointer are stored on the hardware stack during function prologue. They can be stored either separately, or XOR'd together. During function epilogue, return addresses 216 are popped until there is a match between both hardware stack 318 and process stack 208 return addresses and the process stack and hardware stack pointer. The return addresses 216 are compared (e.g., “xored”) with the current stack pointer 224 and the result is stored in hardware stack 318 when the call instruction is executed. In at least one embodiment, both the return address and the current stack frame pointer for each function return address are stored, as more fully described in the attached Appendix, which, as mentioned above, is incorporated herein by this reference.

In the illustrated embodiment, the XOR function is used to handle the case in which the same return address 216 is pushed on hardware stack 318 multiple times before the longjmp function is called. By using XOR, with the stack pointer, the correct position in hardware stack 318 to pop to is identified. Thus, hardware stack 318 and process stack 208 are synchronized.

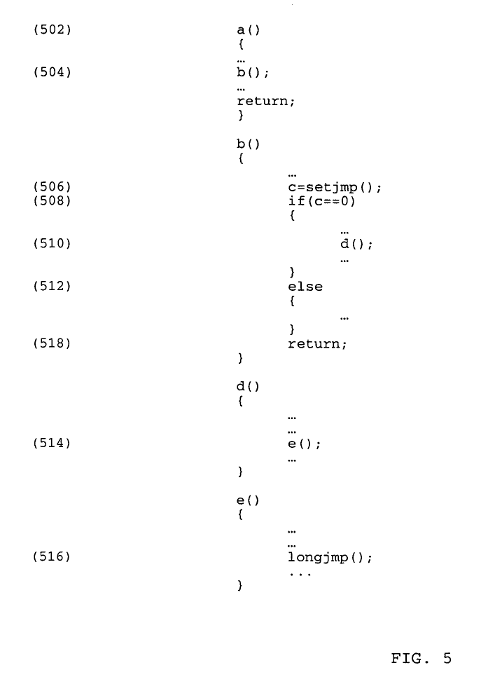

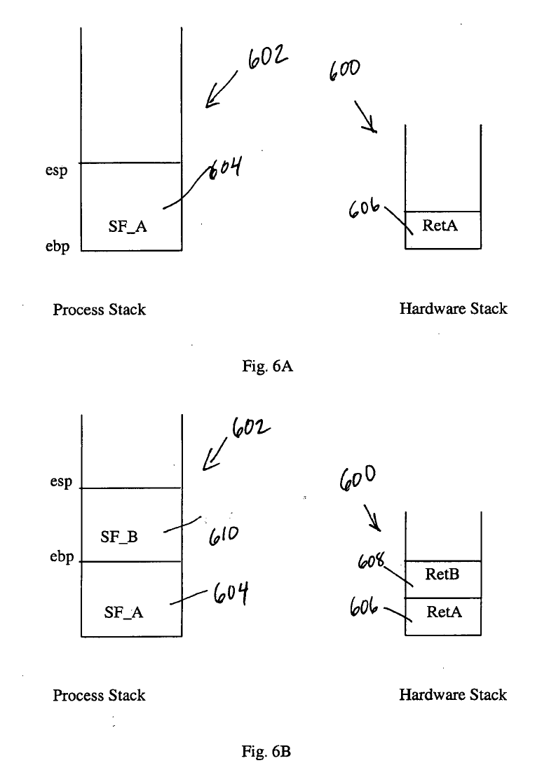

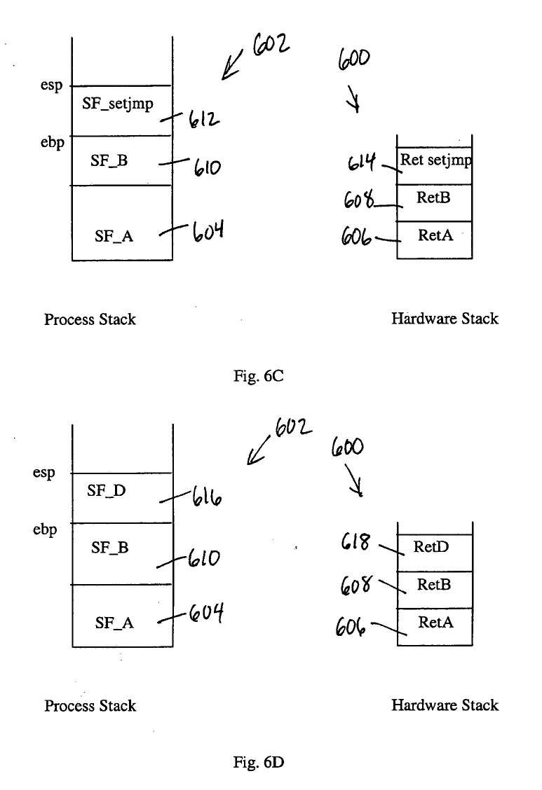

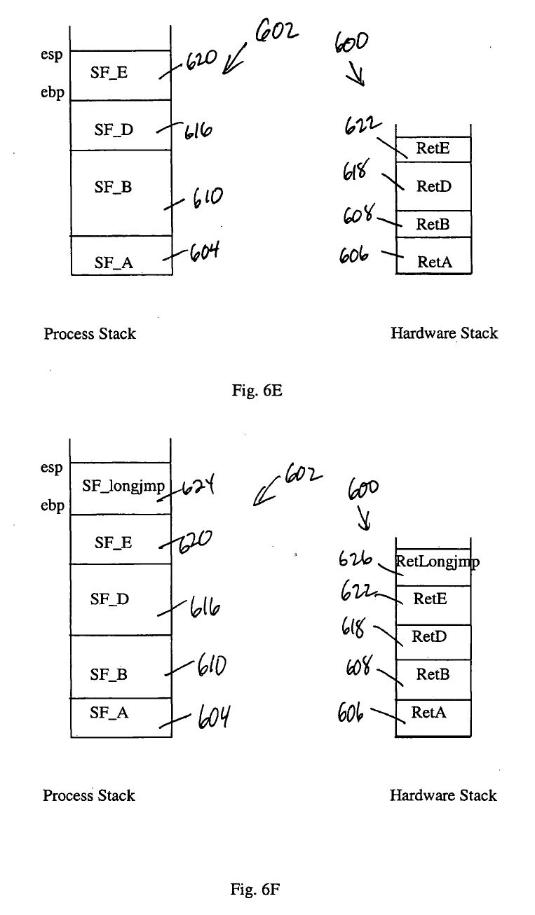

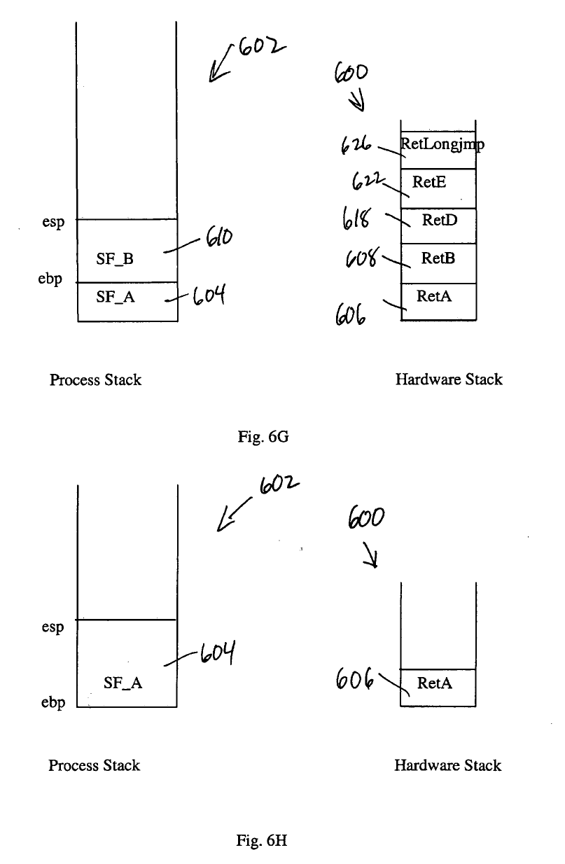

FIG. 5 shows an example code fragment containing function calls and setjmp and longjmp instructions. FIGS. 6A-6H show how the illustrated embodiment responds when these exemplary function calls and setjmp and longjmp instructions are encountered.

In the following discussion of FIGS. 5 and 6A-6H, we use the following notation:

“RetX” means the return address for the function x( ), where x is a, b, c, d, or e, as discussed below;

“SF_x” means the stack frame for the function x( );

“esp” means the stack pointer; and

“ebp” means the base pointer.

FIG. 6A shows the state of hardware stack 600 and process stack 602 at the point (502) that function a( ) is being executed. When function a( ) is called, the call instruction (e.g., bsr or jsr) pushes a's stack frame 604 onto process stack 602 and also pushes a's return address 606 onto hardware stack 600. The return address 606 is also contained in the stack frame 604, as discussed above.

FIG. 6B shows the status of hardware stack 600 and process stack 602 at point (504) when function a( ) calls the nested function b( ). The return address 608 for b gets pushed onto the hardware stack 600 and b's stack frame 610 is pushed onto process stack 602.

FIG. 6C shows the status of hardware stack 600 and process stack 602 when a setjmp function is called (e.g., point (506) in FIG. 5). The setjmp stack frame 612 stores the stack pointer esp and the base pointer ebp of the stack frame 610 for the function b( ). It also stores the return address 614 for the function setjmp( ) (Retsetjmp). Retsetjmp 614 is also pushed onto hardware stack 600.

FIG. 6D shows the status of hardware stack 318 and process stack 208 at point (508), when setjmp( ) returns zero. The comparison c==0 is true. Thus, function do is called at point (510). The stack frame 612 from process stack 602 and the return address for the function setjmp 614 from hardware stack 600 are popped as shown. The stack frame 616 for d( ) is then pushed onto the top of process stack 602 as shown. The return address 618 for the function d( ) is also pushed on top of hardware stack 600.

FIG. 6E shows the status of stacks 208, 318 at point (514), when function d( ) calls function e( ). The stack frame 620 for function e( ) is pushed onto process stack 602 and e's return address 622 is pushed onto hardware stack 600 as shown.

FIG. 6F shows the stacks 600, 602 at point (516) when a longjmp( ) instruction is called. The stack frame 624 is pushed onto process stack 602 and the return address 626 is pushed onto hardware stack 600 as shown in the figure. Longjmp changes the stack pointer esp and the base pointer ebp to point to the stack frame 610 of the function b( ). It then executes the jump to the setjmp return address 614 (Retsetjmp) of FIG. 6C.

FIG. 6G shows the state of process stack 602 and hardware stack 600 after longjmp finishes executing. The process stack 602 now returns to the stack frame 610 of the function b( ). Because a setjmp/longjmp occurred, the return address 610 on the top of process stack 602 does not match the return address 626 on top of hardware stack 600.

The address to which longjmp returns is the same as the return address 614 for setjmp. However, this address is not pushed onto hardware stack 600. But, since longjmp “jumps” and “not returns” to this return address it does not need to be stored on hardware stack 600. Assuming longjmp jumps to function b( ) with some value other than zero, b( ) executes the (else) part of the code at function point (512) and returns to point (518) after doing so. When b( ) returns, the stacks 600, 602 are as shown in FIG. 6H. As shown in FIG. 6H, hardware stack 600 is popped until it reaches the return address 608 for function b( ), i.e., RetB.

Additional description of these and other aspects of the present invention is included in the attached Appendix, incorporated herein by reference.

Although the present invention has been described in detail with reference to certain exemplary embodiments, variations and modifications exist and are within the scope and spirit of the present invention as defined and described in the appended claims.

1. An apparatus for protecting a computing device from attacks during operation of the computing device, the apparatus comprising:
an input/output unit,
a control unit coupled to the input/output unit,
an execute unit coupled to the control unit,
a first memory area including memory that is accessible by a user of the computing device, and
a second memory area including memory that is not accessible by the user, the second memory area being configured to store a plurality of return addresses and stack pointers.

2. The apparatus of claim 1, wherein the execute unit is operable to execute a plurality of operations including:
a first operation which stores a first return address in the first memory area and in the second memory area,
a second operation which compares the first return address with a second return address retrieved from the first memory area, and
a third operation which generates an exception if the comparison indicates a mismatch between the first return address and the second return address.

3. The apparatus of claim 1, further comprising a third memory area including memory that is not accessible by a computer user, the third memory area being configured to store a plurality of return addresses and stack pointers.

4. The apparatus of claim 3, wherein the execute unit is operable to execute a plurality of operations including:
a first operation that stores a first return address in the first memory area and in the second memory area,
a second operation that copies the first return address to the third memory area if the second memory area is full,
a third operation that retrieves the first return address from the third memory area,
a fourth operation that compares the first return address with a second return address retrieved from the first memory area, and
a fifth operation that generates an exception if the comparison indicates a mismatch between the first return address and the second return address.

5. A computing device comprising the apparatus of claim 1.

6. A computing device, comprising:
means for receiving data and programming instructions,
means for processing the data according to the instructions,
means for storing return addresses generated by the means for processing in a first memory area,
means for storing the return addresses in a second memory area not accessible by computer users, and
means for evaluating a return address from the first memory area and a return address from the second memory area to determine whether an attack on a return address has occurred.

7. The computing device of claim 6, further comprising:
means for generating an exception if the means for evaluating determines that an attack has occurred.

8. A computer-readable medium comprising instructions that operate to prevent attacks on return addresses during execution of a computer program, the instructions being executable to:
store a first return address in a first memory area,
store the first return address in a second memory area that is not accessible by computer users,
retrieve a second return address from the first memory area,
compare the first return address and the second return address, and
generate an exception if the first return address is different from the second return address.

9. A computer-readable medium, for use in connection with a computing device, the computer-readable medium including a plurality of instructions that when executed protect the computing device from attacks on return addresses, at least a portion of the computer-readable medium comprising a first memory which is:
configured to store a plurality of return addresses during execution of a computer program,
protected from access by users of the computing device during execution of the computer program, and
accessed by instructions that compare the plurality of return addresses with return addresses stored in a second memory in the computing device.

10. A method of preventing attacks on return addresses during execution of a computer program on a computing device, the method comprising the steps of:
storing a first return address in a first memory that is accessible to computer users and in a second memory that is not accessible to computer users,
retrieving a second return address from the first memory,
comparing the first return address and the second return address, and
generating an exception if the results of the comparing step indicate that an attack has been attempted.

11. The method of claim 10, wherein the step of generating an exception includes generating a hardware exception.

12. The method of claim 10, wherein the storing step is performed if a call instruction is encountered in the computer program.

13. The method of claim 12, wherein the retrieving, comparing, and generating, steps are performed if a return instruction is encountered in the computer program.

14. The method of claim 10, wherein the comparing step is performed at the time of a return instruction commit.

15. The method of claim 10, wherein the comparing step includes the steps of:
recognizing when a data port is not available to accomplish the comparison, and
stalling issuing instructions until a data port is available.

16. The method of claim 10, wherein the storing step includes the step of copying the first return address from the second memory into a third memory that is not accessible by computer users.

17. The method of claim 10, further comprising the step of copying at least a portion of the contents of the second memory into a third memory that is not accessible to computer users if a context switch instruction is encountered in the computer program.

18. The method of claim 17, further comprising the step of copying at least a portion of the contents of the third memory into the second memory.

19. The method of claim 10, further comprising the step of comparing at least a portion of the contents of the first memory with at least a portion of the contents of the second memory if a jump instruction is encountered in the computer program.

20. The method of claim 10, further comprising the step of inserting a random number into the first memory if a jump instruction is encountered in the computer program.
